(19) United States
(12) Patent Application Publication
(10) Pub. No.: US 2026/0322861 A1
(43) Pub. Date: Oct. 15, 2026

(54) SYSTEMS AND METHODS FOR PREDICTIVE INFRASTRUCTURE ADAPTATION BASED ON ESTIMATED SESSION DURATION

(71) Applicant: Stats LLC, Chicago, IL (US)

(72) Inventors: Fabián E. Bustamante, Evanston, IL (US); Stefan Birrer, Chicago, IL (US)

(73) Assignee: Stats LLC, Chicago, IL (US)

(21) Appl. No.: 19/646,076

(22) Filed: Apr. 13, 2026

Related U.S. Application Data
(60) Provisional application No. 63/789,127, filed on Apr. 15, 2025.

(51) Int. Cl. H04L 65/1066; H04L 41/16; H04L 43/022; H04L 43/08

(52) U.S. Cl. CPC H04L 65/1066; H04L 41/16; H04L 43/022; H04L 43/08

(57) ABSTRACT

Systems and methods related to performing dynamic infrastructure adaptation for a real-time or near real-time video streaming environment, comprising collecting telemetry data of a user device during an observation window of an active video streaming session, predicting, based on the telemetry data, an estimated duration of the active video streaming session, classifying the active video streaming session as a long-lived session based on the estimated duration, wherein the long-lived session is greater than a session threshold, determining, by an adaptation engine and based on classifying the active video streaming session as a long-lived session and one or more operational constraints, that a mid-session infrastructure adaptation meets a predicted threshold to improve performance or reduce computational cost, and executing the mid-session infrastructure adaptation based on the determining.

### CROSS-REFERENCE TO RELATED APPLICATIONS

This application claims the benefit of priority to U.S. Provisional Patent Application 63/789,127 filed Apr. 15, 2025, the contents of which are incorporated herein by reference for all purposes.

### FIELD OF INVENTION

The present disclosure relates to real-time or near real-time media streaming, and more particularly to systems and methods for dynamic infrastructure adaptation in multi-cloud and edge computing environments based on predictions of session duration for video streaming applications.

### INTRODUCTION

Real-time and near real-time video streaming applications have become a substantial portion of global internet traffic. These applications encompass video conferencing, live broadcasts, online education, cloud gaming, and interactive entertainment experiences. Such applications are sensitive to latency, jitter, packet loss, and service interruptions, as these factors directly affect the quality of experience (QoE) perceived by users. To address the performance demands of these applications, service providers deploy infrastructure across multiple cloud regions, cloud providers, edge computing platforms, etc. The infrastructure supports the use of the applications.

The infrastructure may be scaled up, or sessions on the applications may be migrated based on resource availability, load metrics, or general performance indicators. Infrastructure optimizations such as instance selection, geographic placement, load balancing, and mid-session migration are applied to manage streaming workloads. However, these decisions are typically made without consideration of the expected duration of said sessions. Optimizations are often applied uniformly across sessions or based on aggregate traffic patterns rather than tailored to the specific characteristics and anticipated behavior of each session. This uniform approach creates specific technical inefficiencies: computational resources are wasted when orchestration systems execute unnecessary migrations for sessions that will terminate shortly after migration completes; network bandwidth is consumed by migration traffic that provides no meaningful benefit to short-lived sessions; and service disruptions introduced during migration processes degrade streaming quality metrics including latency, jitter, and packet loss for sessions that would have performed adequately on their original infrastructure assignment.

Session durations in real-time and near real-time streaming applications typically exhibit a heavy-tailed distribution, where a majority of sessions are brief while a minority of sessions persist for extended periods. This statistical behavior creates challenges for infrastructure management. Migrating short-lived sessions may introduce unnecessary overhead and service disruption, as the migration process itself consumes computational resources on orchestration systems, network bandwidth for state transfer and connection re-establishment, and orchestration overhead for coordination across distributed infrastructure components. These technical inefficiencies compound when migration decisions are applied uniformly across sessions without duration awareness. Conversely, retaining long-lived sessions on suboptimal infrastructure may result in unrealized opportunities for cost reduction or performance improvement over the extended duration of those sessions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a method of performing dynamic infrastructure adaptation for a real-time or near real-time video streaming environment, the method comprising collecting telemetry data of a user device during an observation window of an active video streaming session at the user device, predicting, based on the telemetry data, an estimated duration of the active video streaming session, classifying the active video streaming session as a long-lived session based on the estimated duration, wherein the long-lived session is greater than a session threshold, determining, by an adaptation engine and based on classifying the active video streaming session as a long-lived session and based on one or more operational constraints, that a mid-session infrastructure adaptation meets a predicted threshold to improve performance or reduce computational cost, and executing the mid-session infrastructure adaptation based on the determining that the mid-session infrastructure adaptation meets the predicted threshold to improve performance or reduce computational cost.

In some aspects, the techniques described herein relate to the method, wherein the telemetry data comprises at least one of: network latency, jitter, packet loss, connection type, device type, operating system version, initial video resolution, bitrate, or user interactions.

In some aspects, the techniques described herein relate to the method, wherein the predicting step is performed by a trained machine learning model using historical session data as an input.

In some aspects, the techniques described herein relate to the method, wherein executing the mid-session infrastructure adaptation comprises migrating the active video streaming session to a different cloud region, edge location, or cloud service provider.

In some aspects, the techniques described herein relate to the method, wherein the one or more operational constraints comprises at least one of estimated migration overhead, cloud instance cost, real-time network performance metrics, or service level constraints.

In some aspects, the techniques described herein relate to the method, further comprising logging data indicative of a session duration and quality of experience metrics after the active video streaming session has terminated, and using the logged data to update or retrain the adaptation engine.

In some aspects, the techniques described herein relate to the method, further comprising, prior to the determination that the mid-session infrastructure adaptation is expected to improve performance or reduce computational cost, deferring the determination when a confidence score related to the estimated duration of the active video streaming session is below a confidence threshold.

In some aspects, the techniques described herein relate to the method, further comprising receiving, from the user device, information regarding an occasion captured in the active video streaming session, the occasion being one of a sporting occasion, a gaming occasion, a social occasion, a news occasion, an educational occasion, a religious occasion, a workout occasion, or an entertainment occasion, and predicting, further based on the information regarding the occasion, the estimated duration of the active video streaming session.

In some aspects, the techniques described herein relate to the method, further comprising receiving, from the user device, one or more bids related to an occasion captured in the active video streaming session, and predicting, further based on the one or more bids, the estimated duration of the active video streaming session.

In some aspects, the techniques described herein relate to a computing system for performing dynamic infrastructure adaptation for a real-time or near real-time video streaming environment, the system comprising a processor and memory storing instructions that, when executed by the processor, cause the processor to perform acts comprising collecting telemetry data of a user device during an observation window of an active video streaming session at the user device, predicting, based on the telemetry data, an estimated duration of the active video streaming session, classifying the active video streaming session as a long-lived session based on the estimated duration, wherein the long-lived session is greater than a session threshold, determining, by an adaptation engine and based on classifying the active video streaming session as a long-lived session and based on one or more operational constraints, that a mid-session infrastructure adaptation meets a predicted threshold to improve performance or reduce computational cost, and executing the mid-session infrastructure adaptation based on the determining that the mid-session infrastructure adaptation meets the predicted threshold to improve performance or reduce computational cost.

In some aspects, the techniques described herein relate to the computing system, wherein the telemetry data comprises at least one of: network latency, jitter, packet loss, connection type, device type, operating system version, initial video resolution, bitrate, or user interactions.

In some aspects, the techniques described herein relate to the computing system, wherein the predicting step is performed by a trained machine learning model using historical session data as an input.

In some aspects, the techniques described herein relate to the computing system, wherein executing the mid-session infrastructure adaptation comprises migrating the active video streaming session to a different cloud region, edge location, or cloud service provider.

In some aspects, the techniques described herein relate to the computing system, wherein the one or more operational constraints comprises at least one of estimated migration overhead, cloud instance cost, real-time network performance metrics, or service level constraints.

In some aspects, the techniques described herein relate to the computing system, wherein the processor further performs acts comprising logging data indicative of a session duration and quality of experience metrics after the active video streaming session has terminated, and using the logged data to update or retrain the adaptation engine.

In some aspects, the techniques described herein relate to a non-transitory computer readable medium configured to store processor-readable instructions, wherein when executed by a processor, the instructions perform operations comprising collecting telemetry data of a user device during an observation window of an active video streaming session at the user device, predicting, based on the telemetry data, an estimated duration of the active video streaming session, classifying the active video streaming session as a long-lived session based on the estimated duration, wherein the long-lived session is greater than a session threshold, determining, by an adaptation engine and based on classifying the active video streaming session as a long-lived session and based on one or more operational constraints, that a mid-session infrastructure adaptation meets a predicted threshold to improve performance or reduce computational cost, and executing the mid-session infrastructure adaptation based on the determining that the mid-session infrastructure adaptation meets the predicted threshold to improve performance or reduce computational cost.

In some aspects, the techniques described herein relate to the non-transitory computer readable medium, wherein the predicting step is performed by a trained machine learning model using historical session data as an input.

In some aspects, the techniques described herein relate to the non-transitory computer readable medium, wherein executing the mid-session infrastructure adaptation comprises migrating the active video streaming session to a different cloud region, edge location, or cloud service provider.

In some aspects, the techniques described herein relate to the non-transitory computer readable medium, wherein the one or more operational constraints comprises at least one of estimated migration overhead, cloud instance cost, real-time network performance metrics, or service level constraints.

In some aspects, the techniques described herein relate to the non-transitory computer readable medium, wherein the processor further performs acts comprising logging data indicative of a session duration and quality of experience metrics after the active video streaming session has terminated, and using the logged data to update or retrain the adaptation engine.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a computing environment, according to aspects of the present disclosure.

FIG. 2 illustrates a block diagram of another computing environment depicting the streaming prediction system of FIG. 1, according to aspects of the present disclosure.

FIG. 3 illustrates a flowchart for a process involving session duration prediction and infrastructure adaptation, according to aspects of the present disclosure.

FIG. 4 illustrates a flowchart for another process involving session duration prediction and infrastructure adaptation, according to aspects of the present disclosure.

FIG. 5 illustrates a block diagram involving a machine learning-based prediction module, according to aspects of the present disclosure.

FIG. 6 illustrates a block diagram of a training process for a machine learning model, according to aspects of the present disclosure.

FIG. 7A illustrates a block diagram of a computing device, according to aspects of the present disclosure.

FIG. 7B illustrates a block diagram of another computing device, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The disclosed technology provides technical improvements over conventional systems handling streaming applications by enabling session-aware, duration-sensitive infrastructure management for real-time and near real-time video streaming applications. The disclosed technology addresses the technical problem of inefficient infrastructure adaptation that occurs when systems apply uniform optimization decisions without consideration of predicted session duration. Session durations in real-time or streaming applications typically exhibit a heavy-tailed distribution, where a majority of sessions are brief while a minority of sessions persist for extended periods. Migrating short sessions introduces unnecessary overhead and disruption, whereas failing to migrate long sessions leaves potential cost or performance improvements unrealized.

The disclosed technology achieves specific technical effects including reduced network bandwidth consumption by avoiding unnecessary migration traffic for short-lived sessions, reduced computational overhead on orchestration systems by eliminating migration operations that would not yield meaningful benefit, improved latency and QoE metrics for streaming sessions by avoiding disruption to sessions that would not benefit from migration, and more efficient utilization of multi-cloud infrastructure resources by directing optimization efforts toward sessions where benefits exceed costs. The prediction output directly causes the system to selectively trigger or forego infrastructure adaptations based on estimated session duration, and this selective triggering produces the measurable technical improvements in network bandwidth utilization, computational efficiency, and streaming quality metrics.

The disclosed technology uses telemetry data to estimate session duration shortly after session initiation, enabling selective infrastructure adaptations when benefits exceed costs. A telemetry collector gathers telemetry data from user devices following session initiation, including network metrics, device characteristics, and user behavior signals. A prediction engine receives telemetry data and estimates the likely duration of a session, classifying sessions as either short-lived or long-lived using machine learning models or rules-based logic.

A policy engine evaluates whether an infrastructure adaptation should occur based on the predicted duration, system state, and service-level constraints. The policy engine accounts for factors such as migration overhead, cloud pricing, performance metrics, and service level agreements for latency, availability, or packet loss. An infrastructure orchestrator executes adaptation decisions made by the policy engine, such as migrating a session to another cloud provider, edge node, or instance type. A feedback logger records session outcomes including actual duration and quality of experience metrics, and this data may be used to refine prediction models or adaptation policies over time.

Sessions predicted to be short-lived are retained on initial infrastructure to avoid unnecessary disruption. Sessions predicted to be long-lived may be proactively migrated or reallocated to optimize cost, latency, or resource utilization, accepting limited overhead in exchange for long-term benefits. By selectively triggering infrastructure adaptations only when predicted benefits exceed migration costs, the system achieves specific technical effects: network bandwidth consumed by unnecessary migration traffic is reduced because short-lived sessions are not migrated; computational load on orchestration systems is reduced because migration operations are not executed for sessions that would terminate before realizing migration benefits; and streaming quality metrics are maintained by avoiding disruption to sessions that would not benefit from migration. This approach reduces unnecessary migrations, enhances QoE for users, and improves resource utilization across multi-cloud and edge computing environments. The disclosed technology introduces a session-aware, duration-sensitive mechanism for infrastructure management tailored to latency-sensitive and interactive applications.

As used herein, a short-lived session refers to an active video streaming session with an estimated duration less than or equal to a session threshold, and a long-lived session refers to an active video streaming session with an estimated duration greater than the session threshold. The session threshold represents a duration value, measured in time units such as seconds or minutes, that distinguishes sessions where infrastructure adaptation overhead is likely to exceed benefits from sessions where adaptation benefits are likely to exceed overhead. Example threshold values may include 30 seconds, 60 seconds, 2 minutes, 5 minutes, or other values depending on the application context and infrastructure characteristics. The session threshold may be configurable and may vary based on factors such as content type (e.g., live sports versus short-form video clips), infrastructure characteristics (e.g., migration overhead for different cloud providers), or service tier. In some aspects, the session threshold may be determined empirically from historical session duration distributions, such as by setting the threshold at a percentile value (e.g., median, 25th percentile, or 75th percentile) of observed session durations. Alternative classification approaches, such as percentile-based classifications, clustering algorithms, or probability distributions, are described in greater detail elsewhere in this specification.

As used herein, an adaptation engine 203 refers to one or more components configured to evaluate session characteristics and determine infrastructure adaptation decisions. The adaptation engine 203 may comprise the prediction engine 204, the policy engine 206, or a combination thereof. The adaptation engine 203 may be implemented using machine learning models, rules-based logic, or hybrid approaches that combine machine learning predictions with policy-based decision making. The adaptation engine 203 receives telemetry data and other session information as inputs and outputs infrastructure adaptation decisions based on predicted session duration, operational constraints, and service-level requirements.

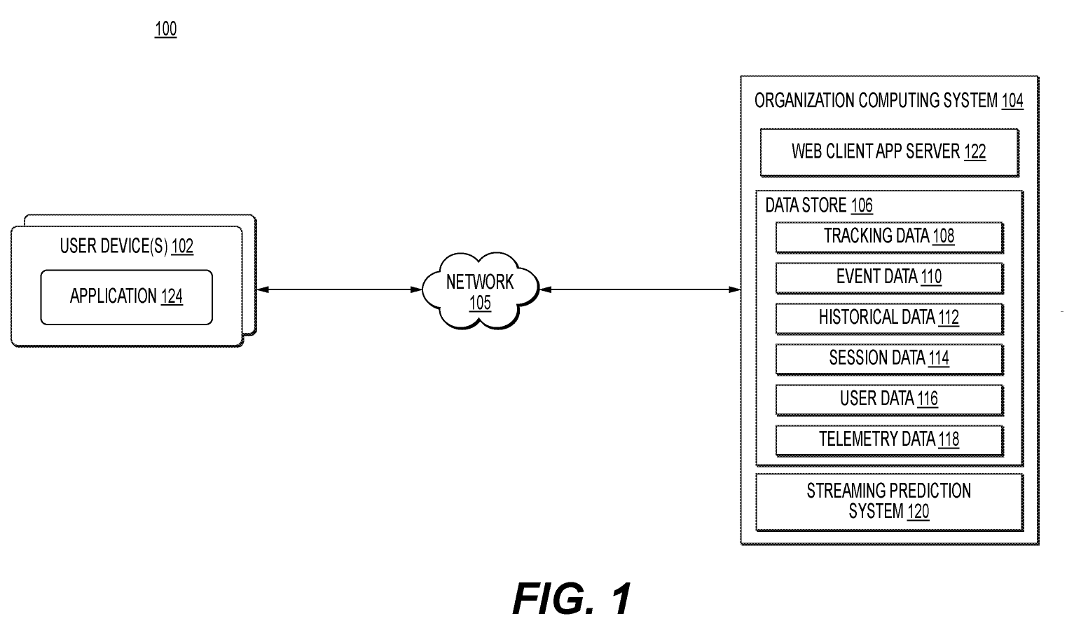

Referring to FIG. 1, a computing environment 100 includes a user device 102, an organization computing system 104, and a network 105 that facilitates communication between the user device 102 and the organization computing system 104. The user device 102 may be a mobile device, a desktop computer, a tablet computer, or another computing device capable of initiating and participating in video streaming sessions. The network 105 may include one or more telecommunications networks, computer networks, wired networks, wireless networks, or combinations thereof.

The organization computing system 104 includes a data store 106 that stores various types of data used for predictive infrastructure adaptation. The data store 106 contains tracking data 108, event data 110, historical data 112, session data 114, user data 116, and telemetry data 118.

The tracking data 108 may include x,y positions of one or more agents and x,y positions of one or more objects associated with occasions captured in video streaming sessions. In the context of sporting occasions, agents may include players, referees, coaches, or other participants, while objects may include balls, pucks, rackets, bats, or other equipment relevant to the sport being streamed. The tracking data 108 may be derived from computer vision systems, sensor arrays, GPS tracking devices, or other position-detection technologies deployed at venues or integrated into streaming production workflows. The tracking data 108 may further include velocity vectors, acceleration data, trajectory predictions, and spatial relationships between agents and objects, enabling the streaming prediction system 120 to assess the current state and anticipated progression of an occasion. For example, tracking data 108 indicating that players are positioned near the center of a field at the start of a match may suggest the occasion is in its early stages, while tracking data 108 showing players clustered near a goal or end zone may indicate a critical moment that could affect viewer engagement and session duration.

The event data 110 may include event information and context information related to occasions occurring during streaming sessions, such as sporting occasions, gaming occasions, social occasions, news occasions, educational occasions, religious occasions, workout occasions, or entertainment occasions. The event information may comprise discrete occurrences or events detected during an occasion, including but not limited to kickoffs, first pitches, goals, points, referee calls, umpire calls, controversial calls, timeouts, substitutions, fouls, penalties, free throws, penalty kicks, red cards, yellow cards, challenges, replay reviews, injuries, medical timeouts, ejections, altercations, records broken, hat tricks, grand slams, holes-in-one, interceptions, fumbles, fumble recoveries, blocked shots, blocked punts, slam dunks, buzzer-beaters, walk-offs, alley-oops, pick-sixes, sacks, offsides, icing, power plays, face-offs, balks, strikeouts, double plays, triple plays, steals, sacrifice flies, passed balls, wild pitches, technical fouls, flagrant fouls, delays of game, false starts, holding, encroachment, roughing, unsportsmanlike conduct, overtime, shootouts, or tiebreakers. The context information may include the type of occasion, the timing of the occasion such as remaining time scheduled or timing relating to specific events, the score or competitive state, the significance of the occasion within a broader competition such as playoffs or championships, and metadata about participants such as team rankings or player statistics. The event data 110 may be generated through automated event detection systems that analyze video feeds, audio streams, or tracking data 108 to identify and classify events in real-time or near real-time. The streaming prediction system 120 may use the event data 110 to refine session duration predictions, as certain events may correlate with increased viewer engagement and extended session duration while other events may indicate natural stopping points where viewers are more likely to terminate sessions.

The historical data 112 may include past session information used for prediction purposes, including data from prior sessions associated with user devices. The historical data 112 may comprise aggregated session duration statistics, distribution patterns of session lengths across different content types, temporal patterns indicating when users typically initiate and terminate sessions, correlation data between initial session characteristics and eventual session outcomes, and performance metrics from prior infrastructure adaptation decisions. The historical data 112 may further include seasonal viewing patterns, event-specific engagement trends, and comparative data across different geographic regions or network conditions. The streaming prediction system 120 may use the historical data 112 to establish baseline expectations for session duration and to identify patterns that correlate with extended or abbreviated viewing behavior. For example, historical data 112 indicating that users who initiate sessions during championship games typically maintain longer session durations than users who join mid-game may inform adaptation engines 203 to weight timing factors accordingly. The historical data 112 may be used as an input to a trained machine learning model for predicting an estimated duration of an active video streaming session, enabling the prediction step to leverage patterns learned from prior sessions. The collection and processing of historical data 112 enables the streaming prediction system 120 to apply learned patterns from past sessions to improve prediction accuracy for current sessions, representing a technical improvement over systems that rely solely on real-time observations without historical context.

The session data 114 may include information about active and past streaming sessions, such as session start and end times, total watch time per session, number of sessions per day, average session duration, drop-off points, rebuffering events, quality switches, and user-initiated actions during sessions. The session data 114 may further include session state information such as current playback position, buffer health, adaptive bitrate ladder position, and connection stability metrics. The session data 114 may also comprise session context information including the content being viewed, the occasion type, concurrent viewer counts, and social engagement metrics such as chat activity or reaction frequency. The streaming prediction system 120 may analyze session data 114 to identify behavioral signatures that distinguish short-lived sessions from long-lived sessions, enabling more accurate classification shortly after session initiation. For example, session data 114 indicating that a user frequently terminates sessions within the first five minutes when initial buffering exceeds a threshold may inform the prediction engine to weight buffering metrics heavily for that user. The session data 114 may be used to log data indicative of a session duration and QoE metrics after an active video streaming session has terminated, and this logged data may be used to update or retrain an adaptation engine 203.

The user data 116 may include user preferences and account information, such as account age, preferred genres, favorite teams or athletes, viewing history, language preferences, saved content, subscription tier, notification settings, social connections, and interactions with the user device 102. The user data 116 may further include demographic information, geographic location, time zone, device ownership history, and engagement metrics such as content completion rates, return visit frequency, and feature adoption patterns. The user data 116 may also comprise user-specific quality preferences, bandwidth allocation priorities, and historical tolerance for quality degradation during network congestion. The user data 116 may be received from the user device 102 and used to predict the estimated duration of the active video streaming session. The streaming prediction system 120 may leverage user data 116 to personalize session duration predictions based on individual user characteristics and historical behavior patterns. For example, user data 116 indicating that a particular user consistently watches entire games of their favorite team but frequently abandons sessions involving other teams may enable the prediction engine to adjust duration estimates based on the content being viewed relative to user preferences.

The telemetry data 118 includes network metrics, device characteristics, and user behavior signals collected from user devices during observation windows of active video streaming sessions. The telemetry data 118 may comprise network latency, jitter, packet loss, round-trip time, throughput measurements, connection type, signal strength, network provider identification, device type, device model, operating system version, application version, screen resolution, initial video resolution, bitrate, codec information, hardware acceleration capabilities, battery level, thermal state, or user interactions. User interactions may include pausing, muting, toggling a camera, adjusting volume, entering or exiting full screen mode, seeking within content, enabling or disabling closed captions, or switching audio tracks. The telemetry data 118 may further include derived metrics such as QoE scores, engagement indicators, attention signals, and anomaly flags indicating unusual network or device behavior. Some telemetry data, such as device type and operating system version, may be available before a session starts, while other data, such as session performance statistics including network latency, jitter, and throughput stability, may require some time to gather after session initiation. The observation window during which telemetry data 118 is collected may be, for example, between approximately three and seven seconds long, enabling rapid session classification while gathering sufficient data for accurate prediction. The streaming prediction system 120 may analyze telemetry data 118 in real-time or near real-time to detect patterns indicative of session duration, such as network instability that correlates with early session termination or high engagement signals that correlate with extended viewing. The telemetry data 118 is used to predict an estimated duration of the active video streaming session, and based on this prediction, the active video streaming session is classified as either a short-lived session or a long-lived session, wherein a short-lived session is less than or equal to a session threshold and a long-lived session is greater than the session threshold. Historical telemetry data of the user device 102, including data from prior sessions, may be stored in the data store 106 or at an external provider.

The organization computing system 104 also includes a streaming prediction system 120 and a web client app server 122. The web client app server 122 handles client-side communications and requests from the user device 102. The user device 102 includes an application 124 that enables interaction with the organization computing system 104 via the network 105. The application 124 may transmit telemetry data 118 to the organization computing system 104 during active video streaming sessions.

The streaming prediction system 120 processes the telemetry data 118 and other data from the data store 106 to predict session duration and determine whether infrastructure adaptations should be executed for streaming sessions. The streaming prediction system 120 may receive information regarding an occasion captured in an active video streaming session from the user device 102 and may predict, further based on the information regarding the occasion, an estimated duration of the active video streaming session. The streaming prediction system 120 may classify sessions as short-lived or long-lived based on estimated duration and may coordinate infrastructure adaptation decisions based on the classification and operational constraints. The components of the computing environment 100 interact to enable predictive infrastructure adaptation for streaming sessions by collecting telemetry data of the user device 102 during an observation window of an active video streaming session at the user device 102.

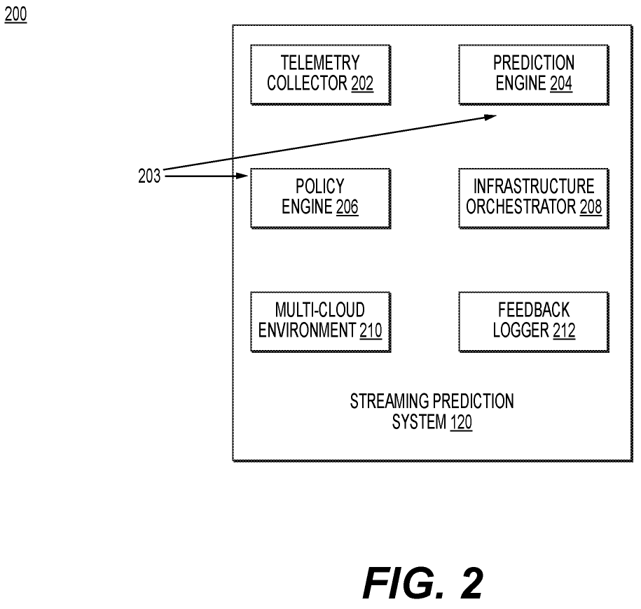

Referring to FIG. 2, another computing environment 200 depicts the streaming prediction system 120 and associated components configured to perform predictive infrastructure adaptation for real-time and near real-time video streaming sessions. The streaming prediction system 120 includes a telemetry collector 202, a prediction engine 204, a policy engine 206, an infrastructure orchestrator 208, a multi-cloud environment 210, and a feedback logger 212. The components of the streaming prediction system 120 interact to enable session-aware infrastructure management based on estimated session duration.

The telemetry collector 202 gathers or receives telemetry data 118 from user devices during streaming sessions. The telemetry collector 202 may receive telemetry data 118 through application programming interfaces exposed by the application 124 on the user device 102. The telemetry collector 202 may establish connections with user devices to enable continuous data collection during streaming sessions. The telemetry collector 202 may poll user devices at regular intervals or may receive telemetry data 118 through event-driven mechanisms where the application 124 transmits data in response to, for example, state changes dictated by user interaction with the user device 102. The telemetry collector 202 may gather telemetry data 118 during an observation window following session initiation, where the observation window may be between three and seven seconds long.

The telemetry collector 202 may perform data preprocessing operations on the telemetry data 118 before providing the data to the prediction engine 204. Data preprocessing may include normalization of telemetry values across different device types and network conditions to enable consistent comparison and analysis. The telemetry collector 202 may perform outlier detection to identify anomalous readings that may indicate sensor errors, network glitches, or unusual device behavior, and may flag or filter such outliers to prevent them from skewing prediction accuracy. The telemetry collector 202 may handle missing or incomplete data through imputation techniques, such as using default values, interpolating from adjacent measurements, or flagging incomplete records for special handling by the prediction engine 204. When telemetry data 118 is received from multiple sources or sensors on the user device 102, the telemetry collector 202 may synchronize the data to ensure temporal alignment, enabling the prediction engine 204 to analyze correlated signals from the same time window. The telemetry collector 202 may also aggregate telemetry data 118 across time windows to compute derived metrics such as rolling averages, variance, and trend indicators that characterize session behavior over time rather than at a single instant.

The prediction engine 204 receives the telemetry data 118 from the telemetry collector 202 and processes the telemetry data 118 to estimate the duration of the streaming session. The prediction engine 204 may analyze the telemetry data 118 (such as data related to latency, jitter, and packet loss) to identify patterns that correlate with session duration, as users experiencing poor network conditions may be more likely to terminate sessions early. The prediction engine 204 may analyze the telemetry data 118 (such as device characteristics including device type, operating system version, and hardware capabilities) to determine whether the user device 102 is capable of sustaining a high-quality streaming experience over an extended period. The prediction engine 204 may assess initial user interactions such as volume adjustments, fullscreen toggles, or camera activations to detect engagement signals that indicate whether a user intends to remain in the session for an extended duration. For sessions involving occasions such as sporting events, the prediction engine 204 may incorporate event timing information to estimate how long a user is likely to continue viewing based on the remaining duration of the occasion. The prediction engine 204 classifies sessions as either short-lived or long-lived based on the estimated duration, where a short-lived session is less than or equal to a session threshold and a long-lived session is greater than the session threshold. The prediction engine 204 may be implemented using a machine learning model trained on historical and/or simulated session data. The machine learning model may be a decision tree, a logistic regression model, a neural network, a deep neural network, a random forest, a gradient boosted machine, or another machine learning architecture. In some cases, the prediction engine 204 may be implemented using a rules-based logic engine based on threshold values derived from empirical session statistics. The prediction engine 204 may output a classification indicating whether the session is short-lived or long-lived and may also output a confidence score indicating the certainty of the prediction. The confidence score may be derived from factors such as the consistency of telemetry signals, the availability of historical data for the user device 102, the clarity of engagement indicators, and the degree to which current session characteristics match patterns observed in prior sessions with known outcomes. When the confidence score falls below a confidence threshold, the policy engine 206 may defer infrastructure adaptation decisions until additional telemetry data is collected or until the confidence score increases above the confidence threshold. The confidence score enables the streaming prediction system 120 to avoid premature or erroneous adaptation decisions when prediction certainty is insufficient, thereby reducing the risk of unnecessary migrations or missed optimization opportunities.

The prediction engine 204 may leverage multiple data sources from the data store 106 to enhance session duration estimation accuracy. The prediction engine 204 may access tracking data 108 to assess the current state and anticipated progression of an occasion being streamed. For sporting occasions, the tracking data 108 may include x,y positions of agents such as players, referees, and coaches, as well as x,y positions of objects such as balls, pucks, or other equipment. The prediction engine 204 may analyze tracking data 108 to determine whether an occasion is in early stages, approaching a critical moment, or nearing conclusion, as these factors significantly influence viewer engagement and expected session duration. For example, tracking data 108 indicating players clustered near a goal or end zone may suggest a critical moment that correlates with extended viewer engagement, while tracking data 108 showing players dispersed across a field during routine play may indicate lower engagement intensity.

The prediction engine 204 may access event data 110 to assess discrete occurrences or events detected during an occasion into session duration predictions. The event data 110 may comprise event information such as goals, penalties, timeouts, controversial calls, injuries, overtime periods, or other significant events that affect viewer engagement. The event data 110 may further comprise context information including the type of occasion, the competitive state such as score differential, and the significance of the occasion within a broader competition such as playoffs or championships. The prediction engine 204 may detect close game scenarios based on score differential, where games with narrow score margins may correlate with extended viewer engagement and increased session duration. In some aspects, when the prediction engine 204 detects a close game scenario, the policy engine 206 may trigger allocation of additional resources or prioritize the session for infrastructure optimization, as viewers of close games may be more likely to maintain extended viewing sessions to observe the outcome. The prediction engine 204 may use event data 110 to identify events that correlate with increased viewer engagement and extended session duration, such as close scores or controversial referee decisions, as well as events that indicate natural stopping points where viewers are more likely to terminate sessions, such as halftime breaks or lopsided scores.

The prediction engine 204 may access historical data 112 to establish baseline expectations for session duration and to identify patterns that correlate with extended or abbreviated viewing behavior. The historical data 112 may comprise aggregated session duration statistics, distribution patterns of session lengths across different content types, temporal patterns indicating when users typically initiate and terminate sessions, and correlation data between initial session characteristics and eventual session outcomes. The prediction engine 204 may use historical data 112 to weight prediction factors based on learned patterns from prior sessions. For example, historical data 112 indicating that users who initiate sessions during championship games typically maintain longer session durations than users who join mid-game may inform the prediction engine 204 to adjust duration estimates based on timing factors.

The prediction engine 204 may access session data 114 to identify behavioral signatures that distinguish short-lived sessions from long-lived sessions. The session data 114 may include information about active and past streaming sessions, such as session start and end times, total watch time per session, drop-off points, rebuffering events, quality switches, and user-initiated actions during sessions. The prediction engine 204 may analyze session data 114 to detect patterns indicative of session duration, such as frequent early terminations when initial buffering exceeds a threshold or extended viewing when initial quality metrics are favorable. The session data 114 may further include session state information such as current playback position, buffer health, and adaptive bitrate ladder position, enabling the prediction engine 204 to assess real-time session health as a factor in duration estimation.

The prediction engine 204 may access user data 116 to personalize session duration predictions based on individual user characteristics and historical behavior patterns. The user data 116 may include user preferences and account information such as account age, preferred genres, favorite teams or athletes, viewing history, language preferences, and subscription tier. The prediction engine 204 may leverage user data 116 to adjust duration estimates based on the content being viewed relative to user preferences. For example, user data 116 indicating that a particular user consistently watches entire games of their favorite team but frequently abandons sessions involving other teams may enable the prediction engine 204 to generate more accurate duration predictions based on the specific content and user combination. The user data 116 may further include user-specific quality preferences and historical tolerance for quality degradation, enabling the prediction engine 204 to assess how network conditions may affect session duration for individual users.

The integration of tracking data 108, event data 110, historical data 112, session data 114, and user data 116 with telemetry data 118 enables the prediction engine 204 to generate comprehensive session duration estimates that account for content characteristics, occasion context, user behavior patterns, and real-time session conditions. This multi-source data integration represents a significant technical improvement over systems that rely solely on network metrics or aggregate traffic patterns, enabling more accurate classification of sessions as short-lived or long-lived and more effective infrastructure adaptation decisions.

The prediction engine 204 is adapted to the streaming infrastructure context by processing telemetry signals that directly measure network and device conditions affecting streaming session behavior. The telemetry data 118 includes network latency, jitter, packet loss, throughput measurements, and connection stability metrics that characterize the technical state of the streaming session and its underlying network path. By analyzing these technical signals, the prediction engine 204 generates session duration estimates that are causally linked to the technical conditions of the streaming environment. The prediction output directly controls whether the infrastructure orchestrator 208 executes migration operations, and this control relationship produces technical effects including reduced network bandwidth consumption when migrations are avoided for short-lived sessions, reduced computational load on orchestration systems when unnecessary migration operations are eliminated, and improved streaming quality metrics when sessions are not disrupted by migrations that would not yield meaningful benefit. This technical adaptation of the prediction engine 204 to the streaming infrastructure context, combined with the causal link between prediction output and infrastructure control decisions, enables the streaming prediction system 120 to achieve measurable improvements in network efficiency, computational resource utilization, and streaming QoE.

The policy engine 206 evaluates whether an infrastructure adaptation should occur based on the predicted duration from the prediction engine 204, system state, and service-level constraints. The policy engine 206 accounts for factors such as migration overhead, cloud pricing, performance metrics, and service level agreements for latency, availability, or packet loss. For sessions classified as short-lived, the policy engine 206 may determine that mid-session infrastructure adaptation does not meet a predicted threshold to improve performance or reduce computational cost, and the policy engine 206 may forego mid-session infrastructure changes to minimize disruption and avoid unnecessary orchestration overhead. For sessions classified as long-lived, the policy engine 206 may evaluate available infrastructure options and determine whether a lower-cost or higher-performance alternative is available and whether migration can be performed within service level agreement constraints. The policy engine 206 may be implemented using a machine learning model trained on historical session data, enabling the policy engine 206 to learn patterns that correlate infrastructure adaptation decisions with session outcomes. The policy engine 206 may be configured to prioritize session stability over cost optimization for sessions classified as short-lived or for predictions with low confidence scores. In a multi-cloud environment, the policy engine 206 may allocate or deallocate resources for different sessions based on system state, such as load and available resources.

The policy engine 206 may calculate cost-benefit thresholds by quantifying both the overhead associated with infrastructure adaptation and the expected benefits over the predicted remaining session duration. Migration overhead may be quantified in terms of estimated disruption duration during the migration process, bandwidth cost for transferring session state and re-establishing connections, and computational cost on orchestration systems for coordinating the migration. Expected benefits may be quantified in terms of cost savings from moving to lower-cost infrastructure over the predicted remaining duration, latency improvement from moving to infrastructure closer to the user or with better performance characteristics, and quality improvement from moving to infrastructure with greater capacity or better network connectivity. The policy engine 206 may weigh competing constraints when they conflict, such as when cost optimization would require migration to infrastructure that does not meet latency requirements specified in service level agreements. In such cases, the policy engine 206 may apply priority rules that favor certain constraints over others or may seek alternative infrastructure options that satisfy all constraints even if not optimal for any single constraint. The policy engine 206 may also handle edge cases such as sessions with borderline classifications where the predicted duration is close to the session threshold, or sessions where confidence scores indicate high uncertainty in the duration prediction. In such edge cases, the policy engine 206 may apply conservative decision rules that favor session stability over optimization or may defer decisions until additional telemetry data reduces prediction uncertainty.

The infrastructure orchestrator 208 executes adaptation decisions made by the policy engine 206. The infrastructure orchestrator 208 may migrate an active video streaming session to a different cloud region, edge location, or cloud service provider within the multi-cloud environment 210. The infrastructure orchestrator 208 may also execute adaptation decisions by scaling compute resources allocated to the session, adjusting bitrate encoding parameters, modifying buffer configurations, reallocating bandwidth allocations, changing instance types to higher or lower performance tiers, activating or deactivating redundant streaming paths, or adjusting quality of service priorities. The infrastructure orchestrator 208 may use standard application programming interfaces or orchestration tools to trigger reallocation, session routing changes, resource scaling operations, or load balancing adjustments. The infrastructure orchestrator 208 may coordinate adaptation actions to minimize disruption to the ongoing session, taking into consideration operational requirements and timing constraints.

The infrastructure orchestrator 208 may manage session state during migration to minimize disruption to the ongoing streaming session. Session state management may include session handoff procedures that coordinate the transfer of session context from source infrastructure to destination infrastructure, ensuring that the destination infrastructure has all necessary information to continue serving the session without interruption. The infrastructure orchestrator 208 may perform buffer synchronization to align playback buffers between source infrastructure and destination infrastructure, reducing the likelihood of rebuffering events or playback discontinuities during the migration. The infrastructure orchestrator 208 may coordinate connection re-establishment with the user device 102, which may involve updating routing information, establishing new network paths, or transferring encryption keys and session tokens. The infrastructure orchestrator 208 may implement rollback procedures that restore the session to its original infrastructure assignment if the migration fails or if post-migration quality metrics indicate degradation below acceptable thresholds. Rollback procedures may be triggered automatically based on quality monitoring or manually by operations personnel. The infrastructure orchestrator 208 may also coordinate with load balancers and DNS systems to redirect traffic from the source infrastructure to the destination infrastructure, ensuring that subsequent requests from the user device 102 are routed to the new infrastructure assignment.

The multi-cloud environment 210 represents available cloud regions, cloud providers, and edge nodes to which streaming sessions may be assigned or migrated. The multi-cloud environment 210 may include infrastructure from multiple public cloud service providers, commercial cloud computing platforms, private cloud deployments, or other cloud computing providers. The multi-cloud environment 210 may further include infrastructure across multiple geographic regions, and edge computing platforms. The streaming prediction system 120 may route sessions to different portions of the multi-cloud environment 210 based on predictions from the prediction engine 204 and decisions from the policy engine 206.

The multi-cloud environment 210 may be evaluated by the policy engine 206 using selection criteria that account for multiple factors when determining optimal infrastructure assignments. Selection criteria for cloud regions and providers may include network latency to the user device 102, available computational and network capacity, cost per unit of compute or bandwidth, compliance requirements such as data residency or sovereignty constraints, and historical reliability metrics for each infrastructure option. The streaming prediction system 120 may perform health monitoring of available infrastructure within the multi-cloud environment 210 to identify degraded or unavailable resources before they are selected for session assignment or migration. Health monitoring may include periodic probing of infrastructure endpoints, analysis of error rates and response times, and integration with cloud provider health dashboards or APIs. The streaming prediction system 120 may implement failover mechanisms that automatically redirect sessions to alternative infrastructure when primary infrastructure becomes unavailable or experiences degradation. Failover mechanisms may include maintaining standby infrastructure assignments for critical sessions, pre-establishing connections to backup infrastructure, and implementing circuit breaker patterns that temporarily remove unhealthy infrastructure from the selection pool until health is restored.

The feedback logger 212 captures and records session outcomes after streaming sessions terminate. The feedback logger 212 may log data indicative of actual session duration and QoE metrics. The QoE metrics may include rebuffering events, quality switches, latency measurements, and user-initiated actions during sessions. The feedback logger 212 may store the logged data for use in refining the one or more adaptation engines 203 and adaptation policies over time.

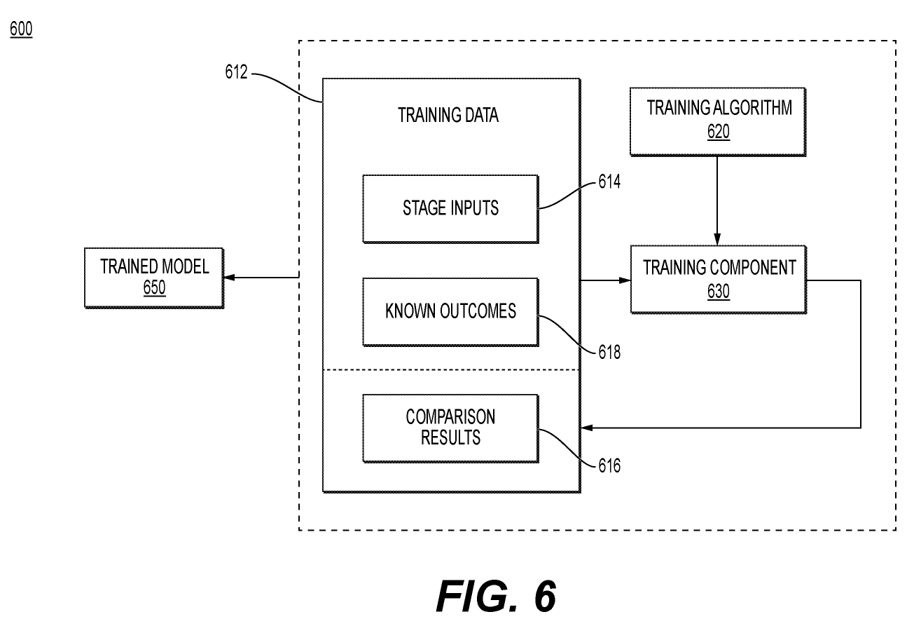

QoE may be a measure of user satisfaction with the streaming experience that encompasses both objective technical metrics and subjective perceptual factors. In the context of video streaming, QoE metrics may include startup delay (time to first frame), rebuffering events (frequency and duration of playback stalls), video resolution stability, audio-video synchronization, frame rate consistency, bitrate adaptation frequency, stall duration and frequency, playback smoothness, and end-to-end latency for interactive sessions. QoE metrics may be derived from objective measurements of network performance data, such as packet loss rates, jitter, and throughput stability, or from user behavior signals, such as session abandonment patterns, user-initiated quality adjustments, and engagement indicators. The prediction engine 204 may use QoE metrics to identify patterns that correlate with session duration, as degraded QoE metrics may correlate with early session termination while favorable QoE metrics may correlate with extended session duration. The feedback logger 212 captures QoE metrics after session termination to provide ground truth data for model refinement, enabling the streaming prediction system 120 to learn relationships between initial session conditions, QoE outcomes, and session duration over time.

Where the prediction engine 204 and the policy engine 206 are machine learning models, the prediction engine 204 and the policy engine 206 may be trained using a training process as described in greater detail with reference to FIG. 6. Briefly, the training process may use training data comprising stage inputs and known outcomes, where the stage inputs represent telemetry data collected from streaming sessions and the known outcomes represent actual session durations and QoE metrics. A training algorithm may apply machine learning techniques including decision trees, logistic regression, neural networks, deep neural networks, convolutional neural networks, recurrent neural networks, Bayesian networks, or decision forests. The training process may receive comparison results that compare predicted outcomes with actual outcomes, enabling iterative refinement of the trained models. The feedback logger 212 provides session outcome data that may be used during scheduled retraining cycles to update the prediction engine 204 and the policy engine 206, enabling continuous improvement of prediction accuracy and adaptation strategies based on accumulated data.

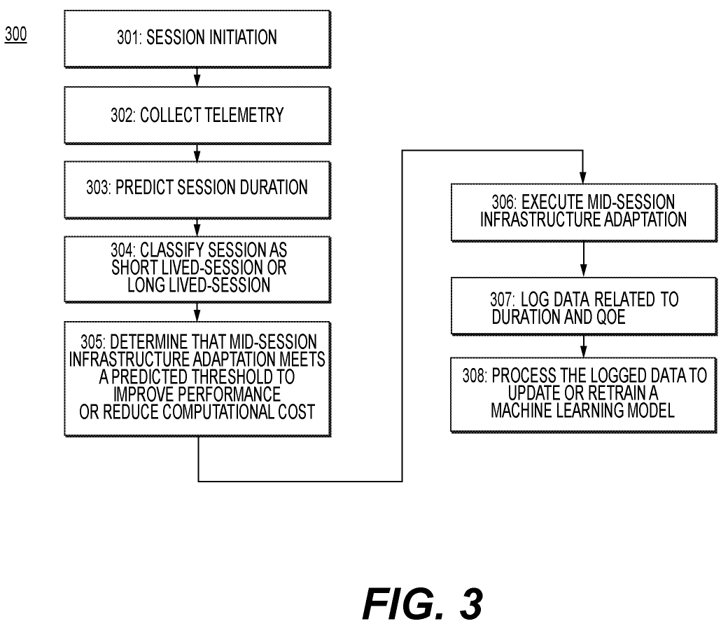

Referring to FIG. 3, a first flowchart 300 illustrates a process for session initiation, telemetry collection, session duration prediction, and infrastructure adaptation in a real-time or near real-time video streaming environment.

The first flowchart 300 begins with a first step 301, where session initiation occurs. A user may initiate a real-time or near real-time video streaming session using an application 124 on a user device 102. The session initiation may involve establishing a connection between the user device 102 and the organization computing system 104 via the network 105. Upon session initiation, the streaming prediction system 120 enters an initial observation window during which telemetry data 118 is collected.

Following session initiation, the process moves to a second step 302, where the streaming prediction system 120 collects telemetry data 118 from the user device 102 during an observation window of the active video streaming session. The telemetry collector 202 may gather telemetry data 118 including network latency, jitter, packet loss, connection type, device type, operating system version, initial video resolution, bitrate, and user interactions. The observation window may be between three and seven seconds long, enabling rapid session classification while gathering sufficient data for accurate prediction. The observation window may be shorter than three seconds or longer than seven seconds, depending on the data being collected, the quality of the connection between the user device 102 and organization computer system 104, etc. Indeed, some telemetry data 118, such as that related to device type and operating system version, may be available before the session starts, while other telemetry data 118, such as that related to network latency, jitter, and throughput stability, may require some time to gather after session initiation. Other data (such as tracking data 108, event data 110, historical data 112, session data 114, and user data 116) may also be gathered at this step.

The process proceeds to a third step 303, where the prediction engine 204 predicts session duration based on the collected telemetry data 118. The prediction engine 204 may analyze the telemetry data 118 to identify patterns that correlate with session duration. The prediction engine 204 may further analyze other data (such as tracking data 108, event data 110, historical data 112, session data 114, and user data 116), as described above to identify patterns that correlate with session duration. The prediction engine 204 may be implemented using a machine learning model trained on historical session data 112, such as a decision tree, a logistic regression model, a neural network, a deep neural network, a random forest, or a gradient boosted machine. In some cases, the prediction engine 204 may be implemented using a rules-based logic engine based on threshold values derived from empirical session statistics. The prediction engine 204 may output a predicted session duration and may also output a confidence score indicating the certainty of the prediction.

At a fourth step 304, the streaming prediction system 120 classifies the active video streaming session as either a short-lived session or a long-lived session based on the predicted duration. A short-lived session may be less than or equal to a session threshold, and a long-lived session may be greater than the session threshold. Alternatively, short-lived sessions and long-lived sessions may be characterized using percentile-based classifications derived from historical session duration distributions, where short-lived sessions fall within a lower percentile range and long-lived sessions fall within an upper percentile range. Sessions may also be characterized using clustering algorithms that group sessions based on duration patterns, engagement metrics, and behavioral signatures without relying on fixed thresholds. Additionally, sessions may be characterized using probability distributions that assign likelihood scores for session duration ranges, enabling continuous rather than binary classification. The classification determines subsequent infrastructure adaptation decisions.

At a fifth step 305, the policy engine 206 determines that a mid-session infrastructure adaptation meets a predicted threshold to improve performance or reduce computational cost. The determination is based on the classification of the active video streaming session as a long-lived session and one or more operational constraints. The one or more operational constraints may comprise estimated migration overhead, cloud instance cost, real-time network performance metrics, or service level constraints for latency, availability, or packet loss. The policy engine 206 may evaluate available infrastructure options within the multi-cloud environment 210 and determine whether a lower-cost or higher-performance alternative is available and whether migration can be performed within service level agreement constraints. When a confidence score related to the estimated duration falls below a confidence threshold, the policy engine 206 may defer the determination until additional telemetry data 118 is collected or until the confidence score increases above the confidence threshold.

At a sixth step 306, the infrastructure orchestrator 208 executes the mid-session infrastructure adaptation. The infrastructure orchestrator 208 may migrate the active video streaming session to a different cloud region, edge location, or cloud service provider within the multi-cloud environment 210. The infrastructure orchestrator 208 may also execute adaptation decisions by scaling compute resources allocated to the session, adjusting bitrate encoding parameters, modifying buffer configurations, reallocating bandwidth allocations, changing instance types to higher or lower performance tiers, activating or deactivating redundant streaming paths, or adjusting quality of service priorities. The infrastructure orchestrator 208 may coordinate adaptation actions to minimize disruption to the ongoing session.

At a seventh step 307, the feedback logger 212 may log data indicative of a session duration and QoE metrics. The QoE metrics may include rebuffering events, quality switches, latency measurements, and user-initiated actions during sessions. The logged data captures actual session outcomes for subsequent analysis and may be stored in the data store 106.

At an eighth step 308, the streaming prediction system 120 processes the logged data to update or retrain a machine learning model. The feedback logger 212 provides session outcome data that may be used during scheduled retraining cycles to update the prediction engine 204 and the policy engine 206. By analyzing the recorded outcomes and comparing the recorded outcomes with predictions, the streaming prediction system 120 enables continuous improvement of prediction accuracy and adaptation strategies based on accumulated data. The eighth step 308 enables the streaming prediction system 120 to apply learned patterns from past sessions to improve prediction accuracy for current sessions.

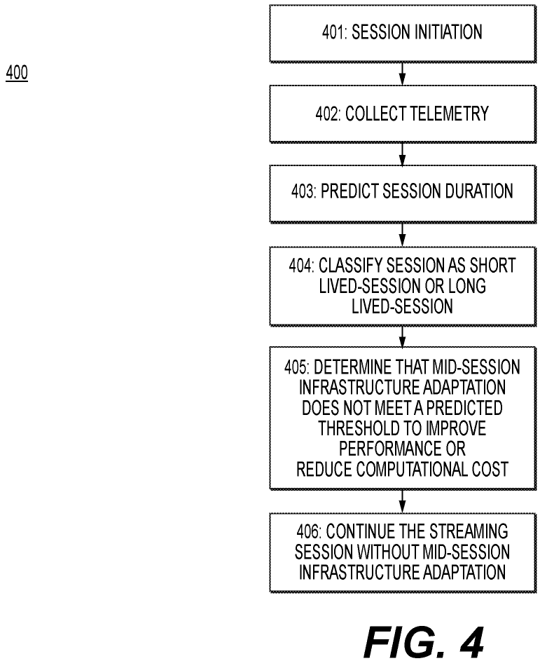

Referring to FIG. 4, a second flowchart 400 illustrates a process for session initiation, telemetry collection, session duration prediction, and continuation of a streaming session without mid-session infrastructure adaptation in a real-time or near real-time video streaming environment.

The second flowchart 400 begins with a first step 401, where session initiation occurs as described with reference to the first step 301 of FIG. 3. A user may initiate a real-time or near real-time video streaming session using an application 124 on a user device 102, and the streaming prediction system 120 enters an initial observation window during which telemetry data 118 is collected.

Following session initiation, the process moves to a second step 402, where the streaming prediction system 120 collects telemetry data 118 from the user device 102 during an observation window of the active video streaming session. The telemetry collection process is performed as described with reference to the second step 302 of FIG. 3, including gathering telemetry data 118 such as network latency, jitter, packet loss, connection type, device type, operating system version, initial video resolution, bitrate, and user interactions. Other data (such as tracking data 108, event data 110, historical data 112, session data 114, and user data 116) may also be gathered at the second step 402.

The process proceeds to a third step 403, where the prediction engine 204 predicts session duration based on the collected telemetry data 118. The prediction process is performed as described with reference to the third step 303 of FIG. 3, including analyzing telemetry data 118 and other data (such as tracking data 108, event data 110, historical data 112, session data 114, and user data 116) to identify patterns that correlate with session duration. The prediction engine 204 may output a predicted session duration and may also output a confidence score indicating the certainty of the prediction.

At a fourth step 404, the streaming prediction system 120 classifies the active video streaming session as either a short-lived session or a long-lived session based on the predicted duration. The classification process is performed as described with reference to the fourth step 304 of FIG. 3, where a short-lived session may be less than or equal to a session threshold and a long-lived session may be greater than the session threshold. The classification determines subsequent infrastructure adaptation decisions.

At a fifth step 405, the policy engine 206 determines that a mid-session infrastructure adaptation does not meet a predicted threshold to improve performance or reduce computational cost. The determination may be based on the classification of the active video streaming session as a short-lived session and one or more operational constraints. The one or more operational constraints may comprise estimated migration overhead, cloud instance cost, real-time network performance metrics, or service level constraints for latency, availability, or packet loss. For sessions classified as short-lived, the policy engine 206 may determine that the overhead associated with mid-session infrastructure adaptation would exceed the benefits achievable during the remaining expected duration of the session. The policy engine 206 may evaluate available infrastructure options within the multi-cloud environment 210 and determine that migration or resource reallocation cannot be performed within service level agreement constraints given the predicted short duration. When a confidence score related to the estimated duration falls below a confidence threshold, the policy engine 206 may defer the determination until additional telemetry data 118 is collected or until the confidence score increases above the confidence threshold.

At a sixth step 406, the streaming prediction system 120 continues the active video streaming session without mid-session infrastructure adaptation. The infrastructure orchestrator 208 maintains the video streaming session on the initial infrastructure assignment without executing migration, resource scaling, or other adaptation actions. The video streaming session continues using the originally allocated cloud region, edge location, or cloud service provider within the multi-cloud environment 210. By foregoing mid-session infrastructure adaptation for sessions classified as short-lived, the streaming prediction system 120 minimizes unnecessary disruption to user experience and avoids orchestration overhead that would not yield sufficient benefit given the predicted short duration of the session.

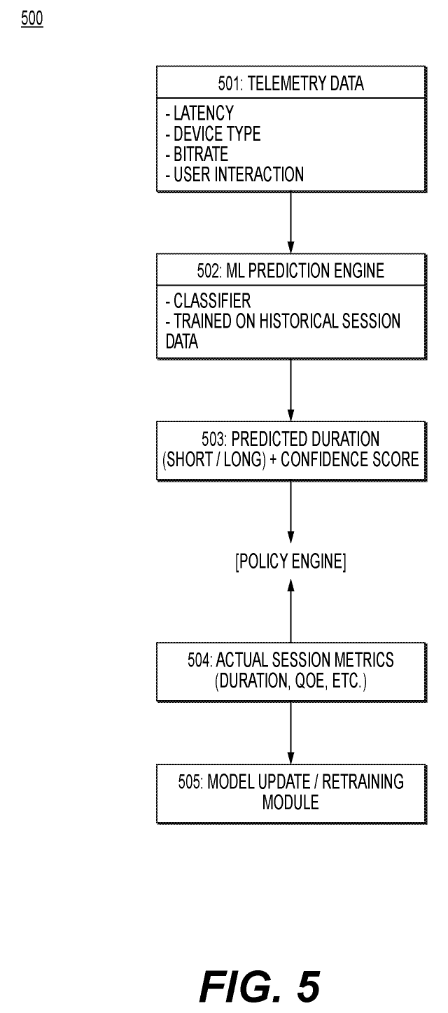

Referring to FIG. 5, a block diagram 500 illustrates an embodiment of a machine learning-based prediction module used to estimate session duration based on telemetry data collected near session initiation. The block diagram 500 depicts the flow of data through the prediction system and a feedback mechanism for model improvement. The machine learning-based prediction module (specifically, a machine learning prediction engine 502) may be implemented as part of the prediction engine 204 described with reference to FIG. 2.

The block diagram 500 includes telemetry data 501, which serves as input to the prediction system. The telemetry data 501 may include various metrics collected from a user device 102 during an observation window of an active video streaming session. The telemetry data 501 may comprise network latency, jitter, packet loss, round-trip time, throughput measurements, connection type, signal strength, network provider identification, device type, device model, operating system version, application version, screen resolution, initial video resolution, bitrate, codec information, hardware acceleration capabilities, battery level, thermal state, or user interactions. User interactions may include pausing, muting, toggling a camera, adjusting volume, entering or exiting fullscreen mode, seeking within content, enabling or disabling closed captions, or switching audio tracks. The telemetry data 501 may correspond to the telemetry data 118 described with reference to FIGS. 1 and FIG. 2.

With continued reference to FIG. 5, the telemetry data 501 is provided to a machine learning prediction engine 502. The machine learning prediction engine 502 processes the telemetry data 501 using a classifier that has been trained on historical session data 112. The machine learning prediction engine 502 may be implemented using a decision tree, a logistic regression model, a neural network, a deep neural network, a random forest, a gradient boosted machine, or another machine learning architecture. In some cases, the machine learning prediction engine 502 may be implemented using a rules-based logic engine based on threshold values derived from empirical session statistics. The machine learning prediction engine 502 analyzes the input features to generate predictions about the expected behavior of the streaming session. The machine learning prediction engine 502 may correspond to the prediction engine 204 described with reference to FIG. 2.

The machine learning prediction engine 502 may also receive and process other data in addition to the telemetry data 501. As described with reference to FIGS. 1 and FIG. 2, the machine learning prediction engine 502 may access tracking data 108 to assess the current state and anticipated progression of an occasion being streamed, such as x,y positions of agents and objects during sporting occasions. The machine learning prediction engine 502 may access event data 110 to incorporate discrete occurrences or events detected during an occasion, such as goals, penalties, timeouts, or controversial calls. The machine learning prediction engine 502 may access historical data 112 to establish baseline expectations for session duration and to identify patterns that correlate with extended or abbreviated viewing behavior. The machine learning prediction engine 502 may access session data 114 to identify behavioral signatures that distinguish short-lived sessions from long-lived sessions. The machine learning prediction engine 502 may access user data 116 to personalize session duration predictions based on individual user characteristics and historical behavior patterns.

As further shown in FIG. 5, the machine learning prediction engine 502 outputs a predicted duration 503. The predicted duration 503 classifies the session as either short-lived or long-lived based on the estimated duration. A short-lived session may be less than or equal to a session threshold, and a long-lived session may be greater than the session threshold. The predicted duration 503 may also include a confidence score indicating the certainty of the prediction. The confidence score may be derived from factors such as the consistency of telemetry signals, the availability of historical data for the user device 102, the clarity of engagement indicators, and the degree to which current session characteristics match patterns observed in prior sessions with known outcomes. The predicted duration 503 is subsequently used by the policy engine 206 to determine whether to execute a mid-session infrastructure adaptation, such as migrating the session to a different cloud region, edge location, or cloud service provider within the multi-cloud environment 210 to optimize performance or reduce costs.

The predicted duration 503 is provided to a policy engine, which may be the same as or similar to the policy engine 206 described with reference to FIG. 2. The policy engine receives the predicted duration 503 and evaluates whether an infrastructure adaptation should occur based on the predicted duration, system state, and service-level constraints. The policy engine accounts for factors such as migration overhead, cloud pricing, performance metrics, and service level agreements for latency, availability, or packet loss. For sessions classified as short-lived based on the predicted duration 503, the policy engine may determine that mid-session infrastructure adaptation would not yield sufficient benefit to justify the associated overhead and disruption. For sessions classified as long-lived, the policy engine may evaluate available infrastructure options and determine whether a lower-cost or higher-performance alternative is available and whether migration can be performed within service level agreement constraints. When the confidence score included in the predicted duration 503 falls below a confidence threshold, the policy engine may defer infrastructure adaptation decisions until additional telemetry data is collected or until the confidence score increases above the confidence threshold.

The block diagram 500 also shows session metrics 504, which represent actual session metrics collected after the session terminates. The session metrics 504 may include data such as actual session duration, rebuffering events, quality switches, latency measurements, and user-initiated actions during sessions. The session metrics 504 provide ground truth information that may be compared against the predicted duration 503 to evaluate prediction accuracy. The session metrics 504 may be captured by the feedback logger 212 described with reference to FIG. 2.

The session metrics 504 may also be fed directly to the policy engine 206 to enable real-time policy adjustments during active sessions. By receiving actual session metrics 504 as sessions progress, the policy engine 206 may compare observed session behavior against initial predictions and adjust infrastructure adaptation decisions accordingly. For example, if a session initially classified as short-lived based on the predicted duration 503 exhibits engagement patterns or duration characteristics that exceed initial expectations, the policy engine 206 may reassess the session classification and determine whether mid-session infrastructure adaptation has become warranted. This direct feedback path enables the policy engine 206 to correct for prediction errors during ongoing sessions rather than relying solely on post-session analysis, thereby improving the responsiveness and accuracy of infrastructure adaptation decisions.

The session metrics 504 also feed into a model update 505. The model update 505 uses the actual session data to refine and improve the one or more adaptation engines 203 over time. By analyzing the recorded outcomes and comparing the recorded outcomes with predictions, the model update 505 enables continuous enhancement of the machine learning prediction engine 502. The model update 505 may be performed during scheduled retraining cycles, during which the machine learning prediction engine 502 is updated based on accumulated session outcome data. The model update 505 may identify patterns and discrepancies between predicted and actual session behaviors, enabling the streaming prediction system 120 to improve prediction accuracy and adaptation strategies based on accumulated data. The feedback mechanism represented by the session metrics 504 and the model update 505 enables the streaming prediction system 120 to apply learned patterns from past sessions to improve prediction accuracy for current sessions.

The streaming prediction system 120 may be applied to various downstream applications that leverage session duration predictions to enhance user experience, optimize resource allocation, and enable new service offerings. The following paragraphs describe several applications that benefit from the predictive infrastructure adaptation capabilities described herein.

In one application, the streaming prediction system 120 may integrate with market prediction platforms to enhance session duration predictions based on user activity associated with market predictions. For example, the streaming prediction system 120 may receive one or more bids related to an occasion captured in the video streaming session from the user device 102. The bids may be placed on sporting events, esports competitions, or other occasions where permitted. Users engaging with the market prediction platforms via bids are statistically more likely to maintain extended viewing sessions to observe the outcome the occasion. The prediction engine 204 may analyze bid information including bid type, bid amount, bet bid relative to occasion progression, and the current state of the bid to refine session duration estimates. For example, a user who has placed a bid on a team that is currently losing by a narrow margin may be predicted to maintain a longer session duration than a user who has not placed a bid.

In another application, the streaming prediction system 120 may support dynamic advertising insertion and monetization strategies based on predicted session duration. For sessions classified as long-lived, the streaming prediction system 120 may signal to advertising systems that extended ad inventory is available, enabling the insertion of longer-form advertisements or sequential ad pods that would be inappropriate for short-lived sessions. Conversely, for sessions classified as short-lived, the streaming prediction system 120 may prioritize high-value, short-duration advertisements to maximize revenue within the limited viewing window. The policy engine 206 may coordinate with advertising decision engines to optimize ad placement timing, ensuring that advertisements are delivered at moments when users are most likely (e.g., above a threshold likelihood) to remain engaged rather than at moments that correlate with session termination.

In a further application, the streaming prediction system 120 may enable personalized content recommendations and engagement interventions based on session duration predictions. When the prediction engine 204 classifies a session as potentially short-lived, the streaming prediction system 120 may trigger engagement interventions designed to extend session duration, such as displaying related content suggestions, enabling social features that connect the user with other viewers, or surfacing interactive elements that increase user investment in the viewing experience. The streaming prediction system 120 may also adjust content delivery parameters for sessions predicted to be long-lived, such as pre-loading upcoming content segments, enabling higher-quality encoding profiles, or activating features that enhance the extended viewing experience.

In an additional application, the streaming prediction system 120 may enable tiered service offerings where users receive differentiated infrastructure treatment based on subscription level, predicted engagement, or other factors. Premium subscribers may be prioritized for migration to optimal infrastructure regardless of predicted session duration, while free-tier users may receive infrastructure adaptations only when sessions are predicted to be long-lived and the cost-benefit analysis favors migration. The policy engine 206 may incorporate subscription tier information from user data 116 when evaluating infrastructure adaptation decisions, enabling service providers to deliver differentiated QoE while managing infrastructure costs.

In a further application, the streaming prediction system 120 may be used to proactively manage network congestion by identifying sessions likely to persist through peak traffic periods and pre-positioning those sessions on infrastructure with greater capacity headroom. When the prediction engine 204 classifies a session as long-lived, the policy engine 206 may evaluate current and anticipated network load conditions and determine whether migrating the session to infrastructure with additional capacity would avoid congestion-related quality degradation during peak periods. By proactively relocating long-lived sessions before congestion occurs, the streaming prediction system 120 produces the technical effect of reduced network congestion during peak periods and improved overall network throughput, as sessions that would otherwise compete for bandwidth during high-traffic periods are distributed across infrastructure with available capacity.

In another application, the streaming prediction system 120 may enable intelligent allocation of scarce edge computing resources to sessions most likely to benefit from low-latency edge infrastructure. Edge computing deployments typically have limited computational and network resources compared to centralized cloud infrastructure. The prediction engine 204 may classify sessions as short-lived or long-lived, and the policy engine 206 may prioritize edge placement for sessions predicted to be long-lived, as these sessions would realize greater cumulative benefit from reduced latency over their extended duration. Sessions predicted to be short-lived may be served from centralized cloud infrastructure, where the slightly higher latency has minimal impact given the brief session duration. This selective allocation produces the technical effect of more efficient utilization of constrained edge computing resources, as limited edge capacity is directed toward sessions where the latency benefits are most significant.

In an additional application, aggregated session duration predictions from the streaming prediction system 120 may feed into capacity planning systems to enable more accurate forecasting of infrastructure demand. By analyzing predicted session durations across active sessions, the streaming prediction system 120 may anticipate infrastructure requirements and proactively provision or deprovision resources before demand changes occur. For example, if a large number of sessions are predicted to be long-lived during an upcoming period, the capacity planning system may provision additional infrastructure in advance. Conversely, if most active sessions are predicted to terminate shortly, the system may defer provisioning or begin deprovisioning underutilized resources. This predictive capacity planning produces the technical effect of reduced over-provisioning costs and improved infrastructure utilization, as resources are allocated based on anticipated demand rather than reactive scaling.

Referring to FIG. 6, a block diagram 600 illustrates a training process for a machine learning model used for predictive infrastructure adaptation in real-time and near real-time video streaming environments. The block diagram 600 depicts the components and data flow involved in training a model that may be deployed within the prediction engine 204 or the policy engine 206 described with reference to FIG. 2.

The block diagram 600 includes training data 612, which serves as input to the training process. The training data 612 comprises stage inputs 614 and known outcomes 618. The stage inputs 614 represent input features or telemetry data collected from streaming sessions. The stage inputs 614 may include network latency, jitter, packet loss, round-trip time, throughput measurements, connection type, signal strength, network provider identification, device type, device model, operating system version, application version, screen resolution, initial video resolution, bitrate, codec information, hardware acceleration capabilities, battery level, thermal state, and user interactions. The stage inputs 614 may further include tracking data 108, event data 110, historical data 112, session data 114, and user data 116 associated with streaming sessions. The stage inputs 614 may be from any applicable source including a component or set shown in the figures provided herein.

The known outcomes 618 represent actual session durations and QoE metrics that correspond to the stage inputs 614. The known outcomes 618 provide ground truth labels for supervised learning, enabling the training process to establish correlations between input features and session duration outcomes. The known outcomes 618 may include actual session duration values, session classification labels indicating whether sessions were short-lived or long-lived, rebuffering event counts, quality switch frequencies, latency measurements, and user-initiated actions during sessions. The known outcomes 618 may be included for machine learning models generated based on supervised or semi-supervised training. An unsupervised machine learning model may not be trained using known outcomes 618.

The block diagram 600 further includes a training algorithm 620 and a training component 630. The training algorithm 620 defines the learning methodology applied during the training process. The training algorithm 620 may utilize machine learning networks and models including deep learning networks such as Deep Neural Networks, Convolutional Neural Networks, Fully Convolutional Networks, and Recurrent Neural Networks. The training algorithm 620 may also utilize probabilistic models such as Bayesian Networks and Graphical Models, and discriminative models such as Decision Forests and maximum margin methods. The training algorithm 620 may further include decision trees, logistic regression, random forests, gradient boosted machines, or other machine learning approaches suitable for session duration prediction.

The training component 630 receives the training data 612 and applies the training algorithm 620 to generate a trained model 650. The training component 630 may adjust one or more weights, layers, nodes, biases, and synapses during a training phase. During the training phase, historical or simulated data may be provided as inputs to the training component 630. The training component 630 may adjust one or more weights, layers, and biases based on the historical or simulated information. The adjusted weights, layers, and biases may be configured in a production version of the trained model 650 based on the training.

As further shown in FIG. 6, the training component 630 also receives comparison results 616. The comparison results 616 represent feedback data comparing predicted outcomes with actual outcomes. The comparison results 616 may compare a previous output of the corresponding machine learning model to apply the previous result to re-train the machine learning model. The comparison results 616 enable the training component 630 to evaluate model performance and adjust model parameters accordingly. The training component 630 may use the comparison results 616 to update the corresponding machine learning model. The feedback mechanism represented by the comparison results 616 supports iterative refinement of the trained model 650 over time, enabling continuous improvement of prediction accuracy based on accumulated session outcome data.

The trained model 650 represents the output of the training process depicted in the block diagram 600. The trained model 650 is configured to receive telemetry data from active streaming sessions and predict estimated session durations. The trained model 650 may classify sessions as short-lived or long-lived based on the estimated duration, where a short-lived session is less than or equal to a session threshold and a long-lived session is greater than the session threshold. The trained model 650 may be deployed as the prediction engine 204 to support infrastructure adaptation decisions in multi-cloud and edge computing environments. Once trained, the trained model 650 may output machine learning model outputs in accordance with the predictive infrastructure adaptation functionality described herein. The trained model 650 may continuously update based on feedback associated with use or implementation of the machine learning model outputs, as captured by the feedback logger 212 described with reference to FIG. 2.

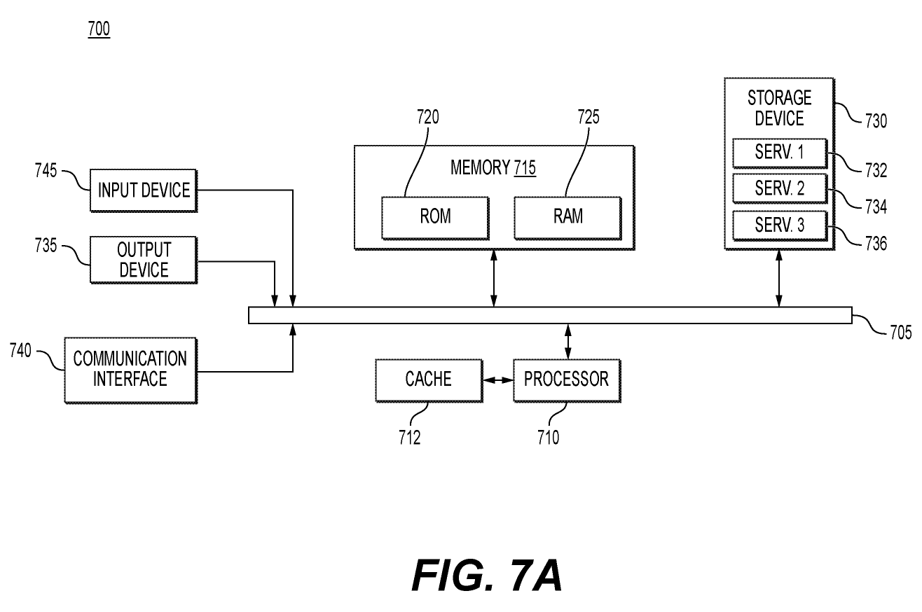

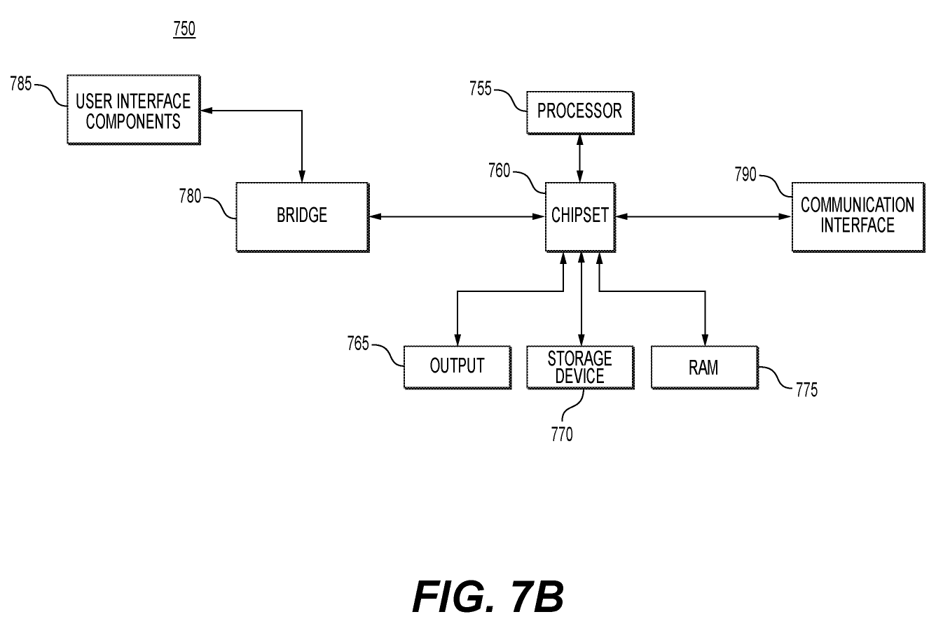

Referring to FIG. 7A, a block diagram 700 illustrates an architecture of a computing device that may be used to implement at least some operations described herein. The computing device depicted in the block diagram 700 may be representative of at least a portion of the organization computing system 104, the user device 102, or other computing devices configured to perform predictive infrastructure adaptation for real-time and near real-time video streaming sessions. One or more components of the computing device may be in electrical communication with each other using a bus 705. The computing device may include a processing unit (CPU or processor) 710 and the bus 705 that couples various system components including a memory 715 to the processor 710. The memory 715 may include read only memory (ROM) 720 and random access memory (RAM) 725.

The computing device may include a cache 712 of high-speed memory connected directly with, in close proximity to, or integrated as part of the processor 710. The computing device may copy data from the memory 715 and a storage device 730 to the cache 712 for quick access by the processor 710. The cache 712 may provide a performance boost that avoids processor 710 delays while waiting for data. The memory 715 may include multiple different types of memory with different performance characteristics. The processor 710 may include any general purpose processor and a hardware module or software module, such as a service 1732, a service 2734, and a service 3736 stored in the storage device 730, configured to control the processor 710 as well as a special-purpose processor where software instructions are incorporated into the actual processor design. The processor 710 may be a self-contained computing system, containing multiple cores or processors, a bus, memory controller, cache, or other components. A multi-core processor may be symmetric or asymmetric.

To enable user interaction with the computing device depicted in the block diagram 700, an input device 745 may represent any number of input mechanisms, such as a microphone for speech, a touch-sensitive screen for gesture or graphical input, keyboard, mouse, motion input, speech, or other input mechanisms. An output device 735 may be one or more of a number of output mechanisms, such as a display. In some cases, multimodal systems may enable a user to provide multiple types of input to communicate with the computing device. A communication interface 740 may govern and manage user input and system output. The communication interface 740 may enable the computing device to communicate with external entities over a network, such as the network 105. The communication interface 740 may include network adapters, wireless interfaces, routers, or other communication components that facilitate data exchange with other devices and systems in the streaming environment.

The storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories, read only memory, and hybrids thereof. The storage device 730 may include the service 1 732, the service 2 734, and the service 3 736 for controlling the processor 710. Other hardware or software modules are contemplated. The storage device 730 may be connected to the bus 705. A hardware module that performs a particular function may include a software component stored in a computer-readable medium in connection with hardware components, such as the processor 710, the bus 705, the output device 735, and other components, to carry out the function. The services stored in the storage device 730 may include software components configured to implement the predictive infrastructure adaptation functionality described herein, including collecting telemetry data 118, predicting session duration, classifying sessions as short-lived or long-lived, and executing infrastructure adaptation decisions.

Referring to FIG. 7B, a block diagram 750 illustrates another architecture of a computing device having a chipset architecture that may represent at least a portion of the organization computing system 104. The computing device depicted in the block diagram 750 may be an example of computer hardware, software, and firmware that may be used to implement the disclosed technology. The block diagram 750 may include a processor 755, representative of any number of physically and logically distinct resources capable of executing software, firmware, and hardware configured to perform identified computations. The processor 755 may communicate with a chipset 760 that may control input to and output from the processor 755. The chipset 760 outputs information to an output 765, such as a display, and may read and write information to a storage device 770, which may include magnetic media and solid-state media. The chipset 760 may also read data from and write data to RAM 775.

A bridge 780 for interfacing with a variety of user interface components 785 may be provided for interfacing with the chipset 760. The user interface components 785 may include a keyboard, a microphone, touch detection and processing circuitry, a pointing device such as a mouse, and other input mechanisms. Inputs to the computing device depicted in the block diagram 750 may come from any of a variety of sources, including machine generated and human generated inputs. The chipset 760 may also interface with one or more communication interfaces 790 that may have different physical interfaces. The communication interfaces 790 may include interfaces for wired and wireless local area networks, for broadband wireless networks, as well as personal area networks. The computing device may receive inputs from a user through the user interface components 785 and execute appropriate functions by interpreting the inputs using the processor 755.

The computing devices depicted in the block diagram 700 and the block diagram 750 may have more than one processor 710 or processor 755 or may be part of a group or cluster of computing devices networked together to provide greater processing capability. The computing architectures depicted in FIG. 7A and FIG. 7B may implement the streaming prediction system 120, including the telemetry collector 202, the prediction engine 204, the policy engine 206, the infrastructure orchestrator 208, and the feedback logger 212. The processor 710 or the processor 755 may execute instructions stored in the memory 715, the storage device 730, or the storage device 770 to perform operations including collecting telemetry data 118 from user devices during observation windows of active video streaming sessions, predicting estimated session durations using machine learning models or rules-based logic, classifying sessions as short-lived or long-lived based on estimated duration, determining whether mid-session infrastructure adaptations meet predicted thresholds to improve performance or reduce computational cost, and executing infrastructure adaptations within the multi-cloud environment 210.

A number of implementations have been described. Nevertheless, it will be understood that various modifications may be made without departing from the spirit and scope of the disclosure. Accordingly, other implementations are within the scope of the following claims.

1. A method of performing dynamic infrastructure adaptation for a real-time or near real-time video streaming environment, the method comprising:
collecting telemetry data of a user device during an observation window of an active video streaming session at the user device;
predicting, based on the telemetry data, an estimated duration of the active video streaming session;
classifying the active video streaming session as a long-lived session based on the estimated duration, wherein the long-lived session is greater than a session threshold;
determining, by an adaptation engine and based on classifying the active video streaming session as a long-lived session and based on one or more operational constraints, that a mid-session infrastructure adaptation meets a predicted threshold to improve performance or reduce computational cost; and
executing the mid-session infrastructure adaptation based on the determining that the mid-session infrastructure adaptation meets the predicted threshold to improve performance or reduce computational cost.

2. The method of claim 1, wherein the telemetry data comprises at least one of: network latency, jitter, packet loss, connection type, device type, operating system version, initial video resolution, bitrate, or user interactions.

3. The method of claim 1, wherein the predicting step is performed by a trained machine learning model using historical session data as an input.

4. The method of claim 1, wherein executing the mid-session infrastructure adaptation comprises:
migrating the active video streaming session to a different cloud region, edge location, or cloud service provider.

5. The method of claim 1, wherein the one or more operational constraints comprises at least one of estimated migration overhead, cloud instance cost, real-time network performance metrics, or service level constraints.

6. The method of claim 1, further comprising:
logging data indicative of a session duration and quality of experience metrics after the active video streaming session has terminated; and
using the logged data to update or retrain the adaptation engine.

7. The method of claim 1, further comprising, prior to the determination that the mid-session infrastructure adaptation is expected to improve performance or reduce computational cost:
deferring the determination when a confidence score related to the estimated duration of the active video streaming session is below a confidence threshold.

8. The method of claim 1, further comprising:
receiving, from the user device, information regarding an occasion captured in the active video streaming session, the occasion being one of a sporting occasion, a gaming occasion, a social occasion, a news occasion, an educational occasion, a religious occasion, a workout occasion, or an entertainment occasion; and
predicting, further based on the information regarding the occasion, the estimated duration of the active video streaming session.

9. The method of claim 1, further comprising:
receiving, from the user device, one or more bids related to an occasion captured in the active video streaming session; and
predicting, further based on the one or more bids, the estimated duration of the active video streaming session.

10. A computing system for performing dynamic infrastructure adaptation for a real-time or near real-time video streaming environment, the system comprising:
a processor; and
memory storing instructions that, when executed by the processor, cause the processor to perform acts comprising:
collecting telemetry data of a user device during an observation window of an active video streaming session at the user device;
predicting, based on the telemetry data, an estimated duration of the active video streaming session;
classifying the active video streaming session as a long-lived session based on the estimated duration, wherein the long-lived session is greater than a session threshold;
determining, by an adaptation engine and based on classifying the active video streaming session as a long-lived session and based on one or more operational constraints, that a mid-session infrastructure adaptation meets a predicted threshold to improve performance or reduce computational cost; and
executing the mid-session infrastructure adaptation based on the determining that the mid-session infrastructure adaptation meets the predicted threshold to improve performance or reduce computational cost.

11. The computing system of claim 10, wherein the telemetry data comprises at least one of: network latency, jitter, packet loss, connection type, device type, operating system version, initial video resolution, bitrate, or user interactions.

12. The computing system of claim 10, wherein the predicting step is performed by a trained machine learning model using historical session data as an input.

13. The computing system of claim 10, wherein executing the mid-session infrastructure adaptation comprises:
migrating the active video streaming session to a different cloud region, edge location, or cloud service provider.

14. The computing system of claim 10, wherein the one or more operational constraints comprises at least one of estimated migration overhead, cloud instance cost, real-time network performance metrics, or service level constraints.

15. The computing system of claim 10, wherein the processor further performs acts comprising:
logging data indicative of a session duration and quality of experience metrics after the active video streaming session has terminated; and
using the logged data to update or retrain the adaptation engine.

16. A non-transitory computer readable medium configured to store processor-readable instructions, wherein when executed by a processor, the instructions perform operations comprising:
collecting telemetry data of a user device during an observation window of an active video streaming session at the user device;
predicting, based on the telemetry data, an estimated duration of the active video streaming session;
classifying the active video streaming session as a long-lived session based on the estimated duration, wherein the long-lived session is greater than a session threshold;
determining, by an adaptation engine and based on classifying the active video streaming session as a long-lived session and based on one or more operational constraints, that a mid-session infrastructure adaptation meets a predicted threshold to improve performance or reduce computational cost; and
executing the mid-session infrastructure adaptation based on the determining that the mid-session infrastructure adaptation meets the predicted threshold to improve performance or reduce computational cost.

17. The non-transitory computer readable medium of claim 16, wherein the predicting step is performed by a trained machine learning model using historical session data as an input.

18. The non-transitory computer readable medium of claim 16, wherein executing the mid-session infrastructure adaptation comprises:
migrating the active video streaming session to a different cloud region, edge location, or cloud service provider.

19. The non-transitory computer readable medium of claim 16, wherein the one or more operational constraints comprises at least one of estimated migration overhead, cloud instance cost, real-time network performance metrics, or service level constraints.

20. The non-transitory computer readable medium of claim 16, wherein the processor further performs acts comprising:
logging data indicative of a session duration and quality of experience metrics after the active video streaming session has terminated; and
using the logged data to update or retrain the adaptation engine.
